(19) United States
(12) Patent Application Publication
(10) Pub. No.: US 2026/0264407 A1
(43) Pub. Date: Sep. 10, 2026

(54) INKJET IMAGE FORMING APPARATUS

(71) Applicant: KYOCERA Document Solutions Inc., Osaka (JP)

(72) Inventor: Yuichiro KUROKAWA, Osaka (JP)

(73) Assignee: KYOCERA Document Solutions Inc., Osaka (JP)

(21) Appl. No.: 19/553,887

(22) Filed: Mar. 2, 2026

(30) Foreign Application Priority Data
Mar. 10, 2025 (JP) 2025-037562

(51) Int. Cl. B41J 2/165; B41J 2/045; B41J 11/00

(52) U.S. Cl. CPC B41J 2/1652; B41J 2/04508; B41J 2/04573; B41J 2/04586; B41J 2/16585; B41J 11/0085; B41J 11/0095; B41J 2002/1657; B41J 2002/16591

(57) ABSTRACT

An image forming apparatus includes a controller that causes ink heads to perform a flushing operation, including ejecting ink from each of nozzles to one of a plurality of openings, at a different timing from a timing for executing an image forming operation, according to a flushing pattern, by which an ink ejection position is specified. The flushing pattern is determined by increasing the number of nozzles of each of the ink heads, specified with respect to each of the openings, by the number of nozzles of each of the ink heads that are required to eject the ink in duplicate to the opening, to perform an overlapping operation.

### INCORPORATION BY REFERENCE

This application claims priority to Japanese Patent Application No.2025-037562 filed on Mar. 10, 2025, the entire contents of which are incorporated by reference herein.

### BACKGROUND

The present disclosure relates to an inkjet image forming apparatus.

An inkjet printer is configured to form an image on a recording medium, being conveyed by a conveying belt, by ejecting ink from nozzles provided in ink heads, onto the recording medium.

The inkjet printer of a line-head type is configured to perform line flushing, including ejecting the ink from the nozzles so as to pass through openings formed in a conveying belt, at a different timing from the ink ejection onto the recording medium to perform the image forming operation, to prevent clogging of the nozzle due to dried ink, to thereby maintain smooth ink ejection performance. The line flushing is performed, for example, according to a flushing pattern, by which the nozzle of each ink head that ejects the ink to the opening, is designated with respect to each of the openings.

In the inkjet printer of the line-head type, as shown in FIG. 9A, the ink heads 121′ are arranged in a checkerboard pattern along the width direction of the conveying belt, so as to define an overlapping region OL (overlapping rows A1 to A5), where a part of at least one ink head 121′ (first head) in the width direction overlaps with an adjacent ink head 121′ (second head).

### SUMMARY

The disclosure proposes further improvement of the foregoing technique.

In an aspect, the disclosure provides an image forming apparatus including a conveying belt, a plurality of ink heads, and a control device. The conveying belt includes a plurality of openings, and conveys a recording medium. The ink heads each include a plurality of nozzles aligned in a width direction, orthogonal to conveying direction of the conveying belt, and perform an image forming operation by ejecting ink from the plurality of the nozzles, onto the recording medium being conveyed by the conveying belt. The control device includes a processor, and acts as a controller, when the processor executes a control program. The controller causes the ink heads to perform a flushing operation, including ejecting the ink from each of the nozzles to one of the plurality of openings, at a different timing from a timing for executing the image forming operation, according to a flushing pattern, by which the nozzle of each ink head that ejects the ink to the opening, is designated with respect to each of the openings. The plurality of ink heads are arranged in a checkerboard pattern along the width direction, alternately shifted from each other in the conveying direction, so as to define an overlapping region, where a part of at least one ink head in the width direction overlaps with an adjacent ink head. The flushing pattern is determined by increasing a number of nozzles of each of the ink heads, specified with respect to each of the openings, by a number of nozzles of each of the ink heads that are required to eject the ink in duplicate to the opening, to perform an overlapping operation. The controller executes, according to the flushing pattern, the overlapping operation including causing the nozzle of one of the ink heads overlapping with each other, and the nozzle of the other of the ink heads, to eject the ink to whole or part of the overlapping region, in a form of shared operation.

### BRIEF DESCRIPTION OF THE DRAWINGS

FIG. 1 is a functional block diagram schematically showing an essential internal configuration of an image forming apparatus according to an embodiment of the disclosure;

FIG. 2 is a schematic front view showing an image forming device and related parts;

FIG. 3 is a schematic plan view showing an example of the location of ink heads;

FIG. 4A and FIG. 4B are schematic plan views each showing an example of the arrangement of openings formed in a conveying belt;

FIG. 5A is a schematic drawing showing a relation between a first head and a second head of the ink head 121, and a flushing pattern F;

FIG. 5B is a schematic drawing showing an example of line flushing, performed according to the flushing pattern F;

FIG. 6 is a schematic drawing for explaining the positional relation between an ejection position of ink ejected from a nozzle of the ink head, and the opening;

FIG. 7 is a flowchart showing an example of an operation performed by the control device of the image forming apparatus;

FIG. 8A and FIG. 8B are schematic drawings for explaining an overlapping operation according to the embodiment;

FIG. 9A and FIG. 9B are schematic drawings for explaining the overlapping operation;

FIG. 10A and FIG. 10B are schematic drawings for explaining the overlapping operation;

FIG. 11 is a schematic drawing for explaining the positional relation between the ejection position of the ink ejected from the nozzle of the ink head, and the opening; and

FIG. 12 is a schematic drawing for explaining the positional relation between the ejection position of the ink ejected from the nozzle of the ink head, and the opening.

### DETAILED DESCRIPTION

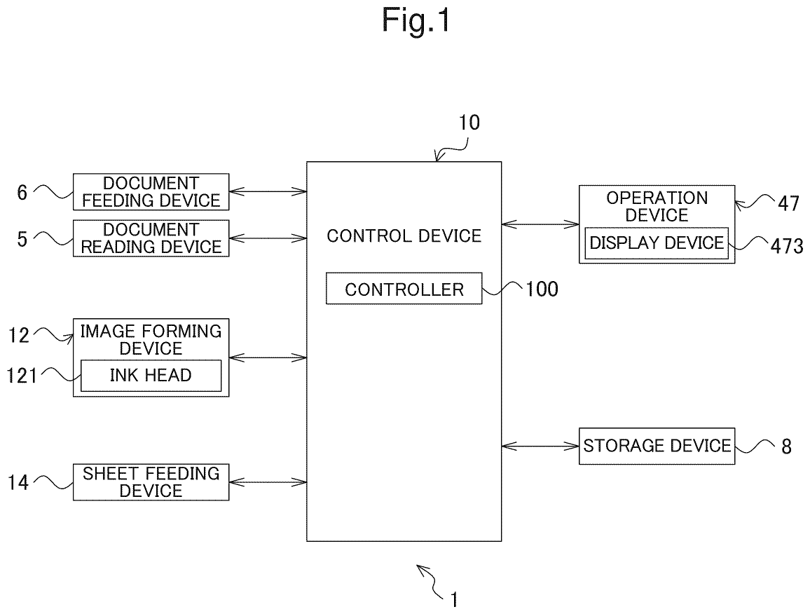

Hereafter, an image forming apparatus according to an embodiment of the disclosure will be described, with reference to the drawings. FIG. 1 is a functional block diagram schematically showing an essential internal configuration of the image forming apparatus according to the embodiment of the disclosure.

The image forming apparatus 1 is a multifunction peripheral having a plurality of functions, such as copying, printing, scanning, and facsimile transmission. The image forming apparatus 1 includes a control device 10, a document feeding device 6, a document reading device 5, an image forming device 12, a sheet feeding device 14, an operation device 47, and a storage device 8.

The document feeding device 6 is openably connected to the upper face of the document reading device 5, for example via a non-illustrated hinge. The document feeding device 6 serves as a document retention cover, when a document placed on a non-illustrated platen glass is to be read. The document feeding device 6, generally called an automatic document feeder (ADF), includes a non-illustrated document tray, and feeds the documents placed on the document tray one by one, to the document reading device 5.

The document reading device 5 includes a scanner, to read the document delivered from the document feeding device 6, or the document placed on the platen glass. The document reading device 5 can also sequentially read a plurality of documents delivered from the document feeding device 6.

To perform the document reading operation, the image forming apparatus 1 operates as follows. The document reading device 5 optically reads the image on the document delivered from the document feeding device 6 to the document reading device 5, or placed on the platen glass, and generates image data. The image data generated by the document reading device 5 is stored, for example, in a non-illustrated image memory.

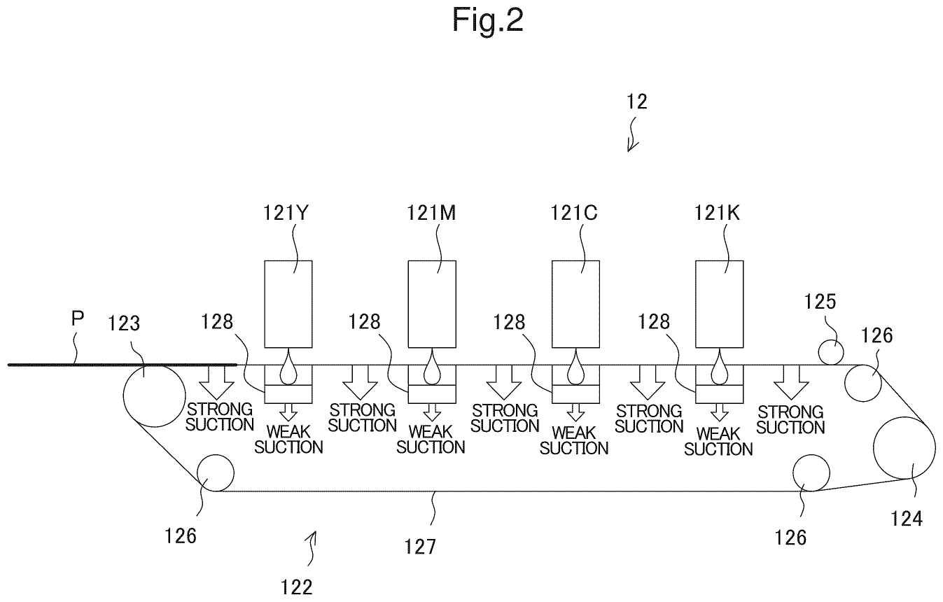

To perform the image forming operation, the image forming apparatus 1 operates as follows. The image forming device 12 includes ink heads 121 that eject ink droplets of four colors (yellow, magenta, cyan, and black) onto a recording sheet, exemplifying the recording medium, to form an image thereon, a printing conveying device 122 (see FIG. 2), and a non-illustrated drying conveying device. The ink heads 121 each include a plurality of nozzles that eject the ink droplets onto the recording sheet.

The image forming device 12 forms an image, by ink jet printing, using the ink which is the recording material, on the recording sheet delivered from the sheet feeding device 14, on the basis of the image data generated through the document reading operation, image data stored in the image memory, or image data received from a computer connected via the network.

The image forming device 12 includes the printing conveying device 122. The printing conveying device 122 includes an endless conveying belt 127, and conveys the recording sheet placed on the conveying belt 127, opposed to the ink heads 121. The drying conveying device also includes, like the printing conveying device 122, an endless conveying belt, and conveys the recording sheet having an image formed thereon and placed on the conveying belt, to naturally dry the ink stuck to the recording sheet.

The sheet feeding device 14 includes a non-illustrated sheet cassette, and also includes a pickup roller, transport rollers, a transport route, and rotational drive mechanism for the rollers, to pick up the recording sheet from the sheet cassette and transport the recording sheet to the image forming device 12.

The operation device 47 includes various hard keys to be operated by the user, and receives the user's instructions inputted with the hard keys, to execute the functions and operations that the image forming apparatus 1 is configured to perform, for example the image forming operation.

The operation device 47 includes a display device 473 for displaying, for example, an operation guide for the user. The operation device 47 receives, through a touch panel provided on the display device 473, the user's instruction based on the touch operation performed by the user on the screen displayed on the display device 473.

The display device 473 includes, for example, a liquid crystal display (LCD). When the user touches a button or a key displayed on the screen, the touch panel receives the instruction corresponding to the touched position. In this case, the touch panel acts as a part of the operation device.

The storage device 8 is a large-capacity storage device such as a hard disk drive (HDD) or a solid-state drive (SSD), and contains various control programs.

The control device 10 includes a processor, a random-access memory (RAM), a read-only memory (ROM), and an exclusive hardware circuit. The processor is, for example, a central processing unit (CPU), an application specific integrated circuit (ASIC), or a micro processing unit (MPU). The control device 10 includes a controller 100.

To be more specific, the control device 10 acts as the controller 100, when the processor operates according to the control program stored in the storage device 8. Here, the controller 100 may be constituted in the form of a hardware circuit, instead of being realized by the operation of the control device 10 according to the control program. This also applies to other embodiments, unless otherwise specifically noted.

The controller 100 serves to control the overall operation of the image forming apparatus 1. The controller 100 is connected to the document feeding device 6, the document reading device 5, the image forming device 12, the sheet feeding device 14, the operation device 47, and the storage device 8, and controls the operation of the mentioned components. The controller 100 also executes some processings required for the image forming operation to be performed by the image forming apparatus 1.

FIG. 2 is a schematic front view showing the image forming device 12 and the related parts. The image forming device 12 includes the ink heads 121Y, 121M, 121C, and 121K (hereinafter, collectively “ink head 121” where appropriate) that respectively eject the ink of four colors, namely yellow, magenta, cyan, and black, onto the recording sheet P, a printing conveying device 122, and a plurality of ink receptacles 128, to form an image on the recording sheet P thus performing a printing operation.

The printing conveying device 122 includes a drive roller 123, a follower roller 124, an adsorption roller 125, a plurality of tension rollers 126, and the conveying belt 127. The conveying belt 127 is an endless belt that conveys the recording sheet P opposed to the ink heads 121, and stretched around the drive roller 123, the follower roller 124, and the tension rollers 126.

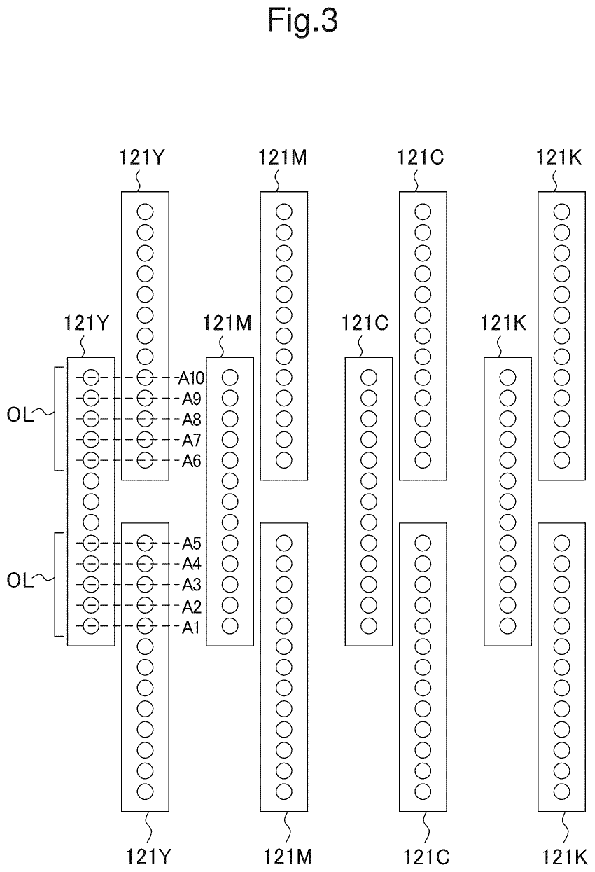

As shown in FIG. 3, the ink heads 121Y, 121M, 121C, and 121K are arranged in a checkerboard pattern along the width direction of the conveying belt 127, so as to define an overlapping region OL, where a part of at least one ink head 121 in the width direction overlaps with the adjacent ink head 121.

The drive roller 123 is driven by a non-illustrated roller driving device including a motor and gears, so as to rotate counterclockwise in FIG. 2. When the drive roller 123 is made to rotate, the conveying belt 127 revolves counterclockwise, and the follower roller 124 and the tension rollers 126 are each passively made to rotate counterclockwise.

The tension rollers 126 each serve to maintain the tension of the conveying belt 127 at an appropriate level. The adsorption roller 125 electrically charges the conveying belt 127, to thereby electrostatically adsorb the recording sheet P delivered from the sheet feeding device 14, to the conveying belt 127.

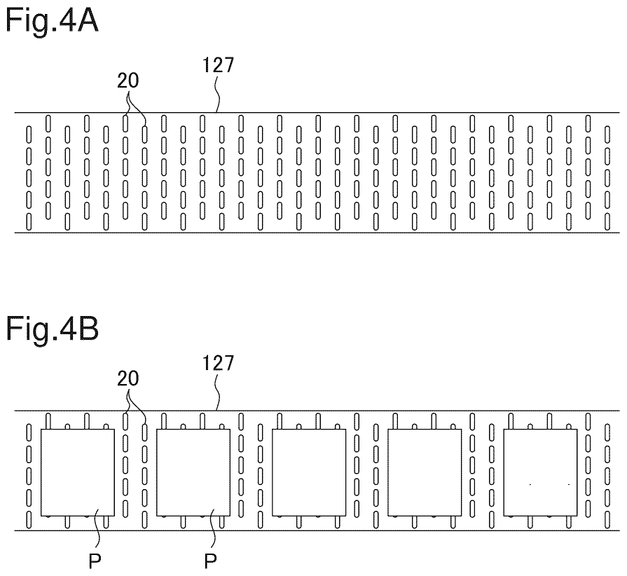

In addition, the conveying belt 127 includes a plurality of openings 20, for the ink ejected from the nozzles of the ink head 121 to pass therethrough, as shown in FIG. 4A. The openings 20 are each formed in an elongate shape extending in the width direction of the conveying belt 127, and arranged in a checkerboard pattern along the width direction of the conveying belt 127.

The ink receptacles 128 are provided on the side of the inner circumferential surface of the conveying belt 127, so as to oppose the respective ink heads 121 across the conveying belt 127. The ink receptacle 128 receives and collects the ink that has been ejected from the ink head 121 and passed through the opening 20, when line flushing, including causing the ink head 121 to eject the ink according to a flushing pattern F, is performed under the control of the controller 100.

In this embodiment, in addition, a non-illustrated negative pressure generator is provided on the lower side of the conveying belt 127, to adsorb the recording sheet P to the conveying belt 127, by negative-pressure suction. Accordingly, the opening 20 also serves as a suction hole for allowing the suction airflow, generated by the negative-pressure suction to pass therethrough. Further, the suction force generated by the negative pressure generator is stronger in the region other than right under the ink head 121.

The controller 100 executes the overlapping operation including causing the nozzles of one of the ink heads 121, and the nozzles of the other ink head 121 overlapping in the width direction of the conveying belt 127, to eject the ink to whole or part of the overlapping region OL, in the form of shared operation.

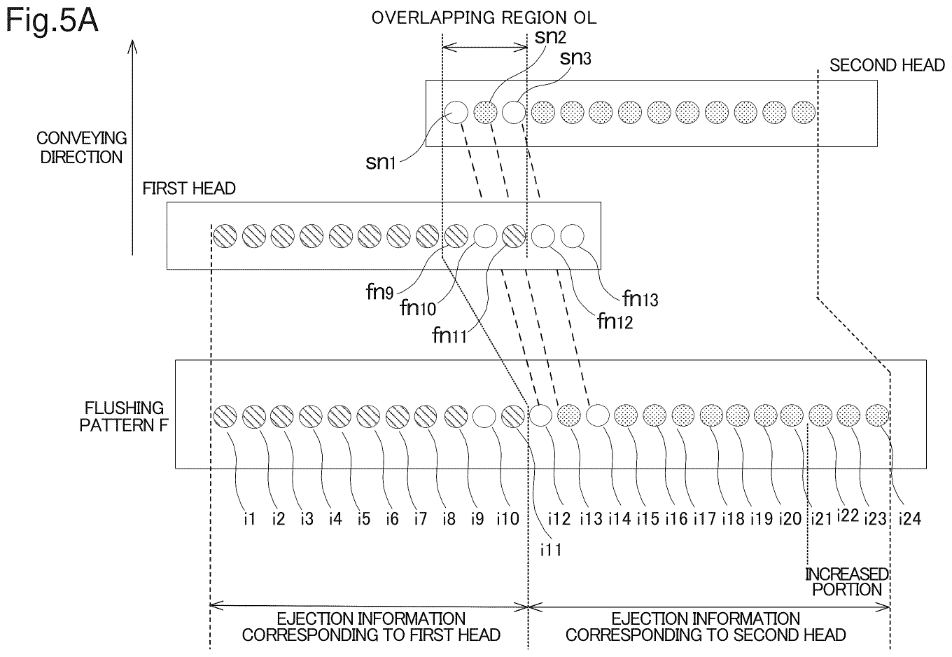

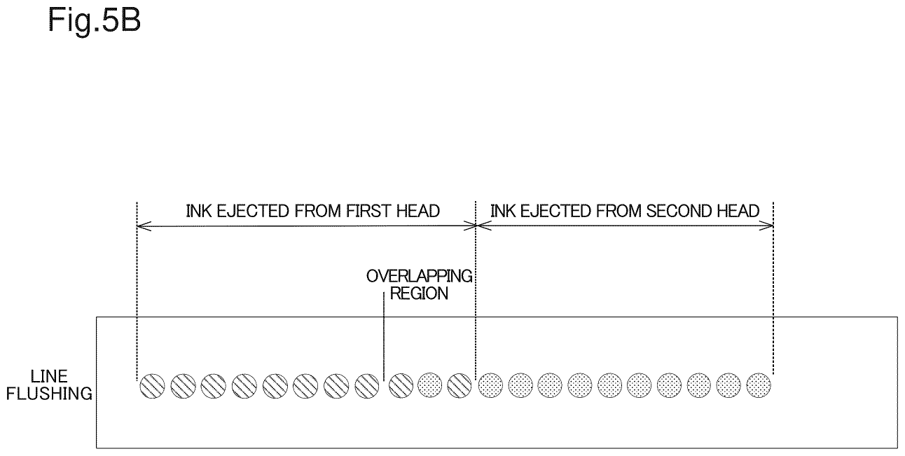

The controller 100 also causes the ink heads 121 to execute the flushing operation, including causing each of the nozzles to eject the ink to one of the plurality of openings 20, at a different timing from a timing for executing the image forming operation, according to the flushing pattern F, by which the nozzle of each ink head that ejects the ink to the opening, is designated with respect to each of the openings. As shown in FIG. 4B, the controller 100 causes the ink heads 121 to execute the line flushing by causing each of the nozzles to eject the ink, at the timing that the opening 20, located between the recording sheets P sequentially conveyed on the conveying belt 127, is opposed to the nozzle. In other words, the controller 100 executes the overlapping operation, when the opening 20 reaches, because of the revolving motion of the conveying belt 127, the ink ejection position from the nozzle along the revolving direction of the conveying belt 127, by causing the corresponding nozzles of a first head and a second head (see FIG. 5A), using the flushing pattern F.

The flushing pattern F is determined by increasing the number of nozzles of each of the ink heads 121, specified with respect to each of the openings 20, by the number of nozzles that are required to eject the ink in duplicate, to perform the overlapping operation.

The mentioned arrangement according to this embodiment, therefore, prevents the ink ejection position from shifting in the width direction with respect to the opening 20, because of the number of nozzles that eject the ink to the opening 20 being fixed, when the line flushing is to be performed, thereby preventing the ink from being ejected to a position where the opening 20 is not formed, which disables the line flushing from being properly performed.

FIG. 5A is a schematic drawing showing a relation between the first head and the second head of the ink head 121, and the flushing pattern F, and FIG. 5B is a schematic drawing showing an example of the line flushing, performed according to the flushing pattern F. In FIG. 5A, circles in the first head and the second head each indicate the nozzle, the circles with an oblique line in the first head indicate the nozzles that eject the ink, and the circles with dots in the second head indicate the nozzles that eject the ink. Circles in FIG. 5B each indicate the ejected ink, the circles with the oblique line indicate the ink ejected from the first head, and the circles with the dots indicate the ink ejected from the second head.

According to the flushing pattern F, as shown in FIG. 5A, ink ejection information i1 to i11, from the first to the eleventh from the left in FIG. 5A, each correspond to the nozzle of the first head. Here, the nozzles fn12 and fn13 at the right end portion of the first head, are non-ejecting nozzles unused for the image forming operation and the line flushing. The ink ejection information i12 to i24, from the twelfth to the twenty-fourth from the left, each correspond to the nozzle of the second head.

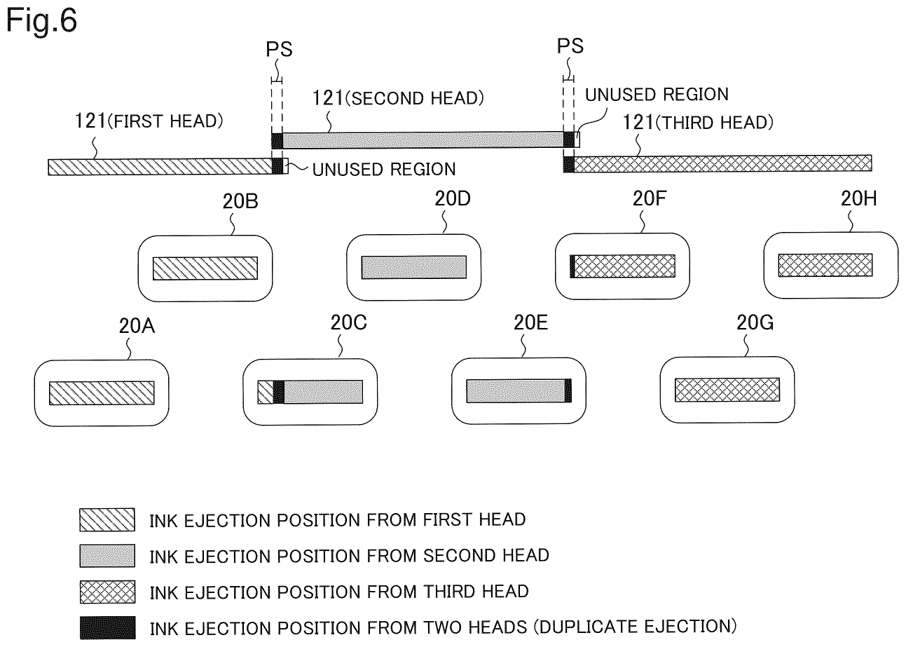

According to the flushing pattern F, the nozzles fn9 and fn11, among the nozzles fn9 to fn11 of the first head corresponding to the overlapping region OL, eject the ink, but not the nozzle fn10, and the nozzle sn2 among the nozzles sn1 to sn3 of the second head corresponding to the overlapping region OL, ejects the ink, but not the nozzles sn1 and sn3. In this example, thus, the flushing pattern F is determined, by increasing the number of pieces of ink ejection information by three, corresponding to the three nozzles used in duplicate from the first head and the second head, with respect to the overlapping region OL. In this example, therefore, eleven nozzles (in the first head, ink ejection information i1 to i11) are set to eject the ink to one of the openings 20, other eleven nozzles, continuous from the first mentioned eleven nozzles, are set to eject the ink to another opening 20, adjacent to the first mentioned opening 20 in the width direction, and likewise, still other eleven nozzles are set to eject the ink to still another opening 20. In such a case, since the number of pieces of ink ejection information is increased by the amount corresponding to the number of nozzles to be used in duplicate, when the controller 100 causes the first head and the second head to eject the ink from the corresponding nozzles according to the flushing pattern F, at the timing that the opening 20 has reached, because of the revolving motion of the conveying belt 127, the ink ejection position from the nozzle along the revolving direction of the conveying belt 127, the ink ejection position can be prevented from shifting in the width direction with respect to the opening 20, thereby enabling the ink to pass through the opening 20, as shown in FIG. 6.

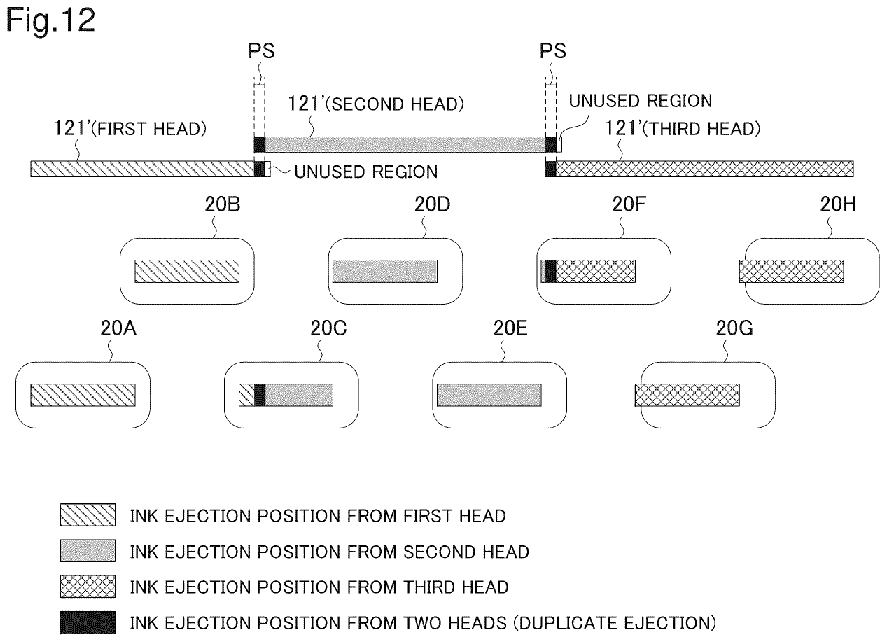

When the line flushing is performed, from two heads (first head and second head) to the openings 20 of a conveying belt similar to the conveying belt 127 according to this embodiment, with the number of nozzles (number of times of ink ejection) in the width direction fixed, with respect to each of the openings 20, according to a flushing pattern that does not increase the number of pieces of ink ejection information by the amount corresponding to the number of nozzles to be used in duplicate, unlike the flushing pattern F according to this embodiment, the ink ejection position from each of the nozzles is shifted in the width direction, by the amount corresponding to the number of nozzles located in duplicate along the conveying direction in the overlapping region, owing to the overlapping operation performed, for example, at the position of the openings 20C and 20F, as shown in FIG. 12. Therefore, the ink is unable to be accurately ejected from the nozzle to the position of the corresponding opening 20.

In the case where a flushing pattern is generated, by changing the nozzles and the number thereof that eject the ink to the opening 20, when the opening 20 has reached the position opposite the nozzle along the conveying direction, according to the position of the openings 20 in the width direction, the overlapping operation and the line flushing can both be properly performed according to the position of the openings. However, complicated generating operation and large memory capacity are required, to generate such a flushing pattern.

With the arrangement according to this embodiment, in contrast, the flushing pattern F can be generated through a simple process and configuration, by simply increasing the number of pieces of ink ejection information by the amount corresponding to the number of nozzles used in duplicate from the first head and the second head, with respect to the overlapping region OL. By utilizing such flushing pattern F, the line flushing, accompanied with the overlapping operation, can be accurately performed without a shift, with respect to the openings 20 of the conveying belt 127.

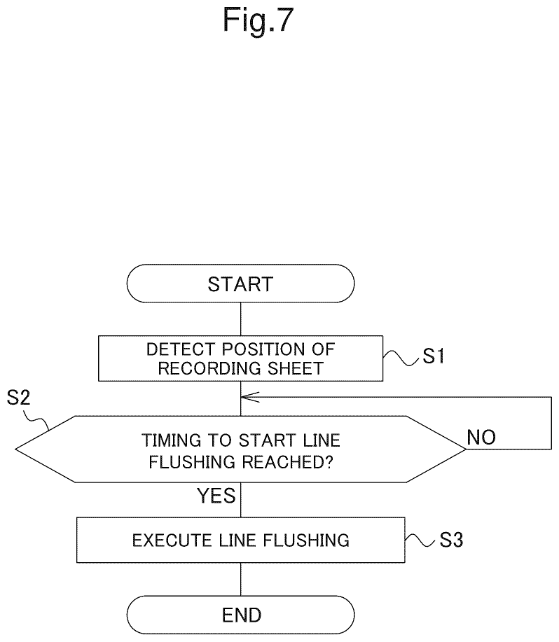

Referring now to a flowchart shown in FIG. 7, an example of the line flushing operation, performed by the control device 10 of the image forming apparatus 1, will be described hereunder. The controller 100 detects the position of the recording sheet P being conveyed on the conveying belt 127, on the basis of a detection signal from a known recording sheet sensor (S1). The controller 100 then decides whether the timing to start the line flushing has been reached, on the basis of the position of the recording sheet P (S2).

Upon deciding that the timing to start the line flushing has been reached (YES at S2), the controller 100 controls the operation of the ink heads 121 according to the flushing pattern F, to thereby perform the line flushing, when the opening 20 has reached the position opposite the nozzle, along the conveying direction (S3). Thereafter, the operation specified in FIG. 7 is finished.

The disclosure may be modified in various manners, without limitation to the foregoing embodiment. For example, according to the embodiment described with reference to FIG. 5A and FIG. 5B, the flushing pattern F is set to eject the ink from the nozzles fn9 and fn11, among the nozzles fn9 to fn11 of the first head corresponding to the overlapping region OL, but not from the nozzle fn10, and to eject the ink from the nozzle sn2, among the nozzles sn1 to sn3 of the second head corresponding to the overlapping region OL, but not from the nozzles sn1 and sn3. Instead, the flushing pattern F may be set to eject the ink from all the nozzles of both of the first head and the second head, with respect to the overlapping region OL.

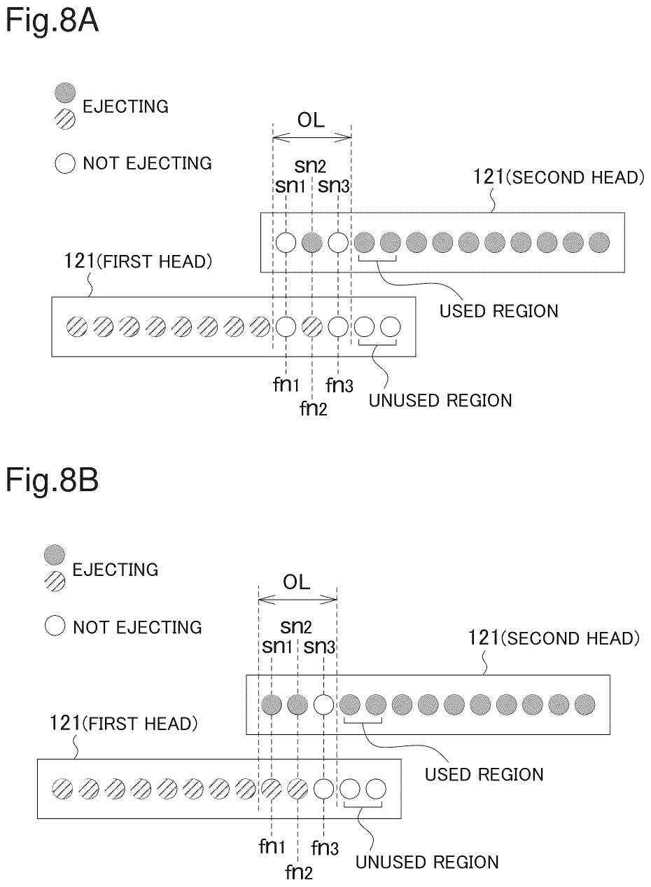

Alternatively, the same pattern may be adopted for both of the first head and the second head, with respect to the overlapping region OL, such that (i) the nozzles fn1 and fn3 of the first head, and the nozzles sn1 and sn3 of the second head do not eject the ink, and the nozzle fn2 of the first head, and the nozzle sn2 of the second head eject the ink, as shown in FIG. 8A, or (ii) the nozzles fn1 and fn2 of the first head, and the nozzles sn1 and sn2 of the second head eject the ink, and the nozzle fn3 of the first head, and the nozzle sn3 of the second head do not eject the ink, as shown in FIG. 8B.

Here, although the nozzles of the first head and the second head that are to eject the ink to the overlapping region OL may be fixed, the nozzles of the first head and the second head to eject the ink to the overlapping region OL may be changed, at a certain cycle during the normal image forming operation, not the line flushing (e.g., each time the line flushing is performed). In this case, to designate the nozzle that ejects the ink to the overlapping region OL at the time of line flushing, between the first head and the second head, the controller 100 may designate the nozzle that has ejected a smaller amount of ink, during the period after the immediately preceding line flushing. Then the controller 100 can generate the flushing pattern F for the designated nozzle to eject the ink, and perform the line flushing according to the flushing pattern F generated.

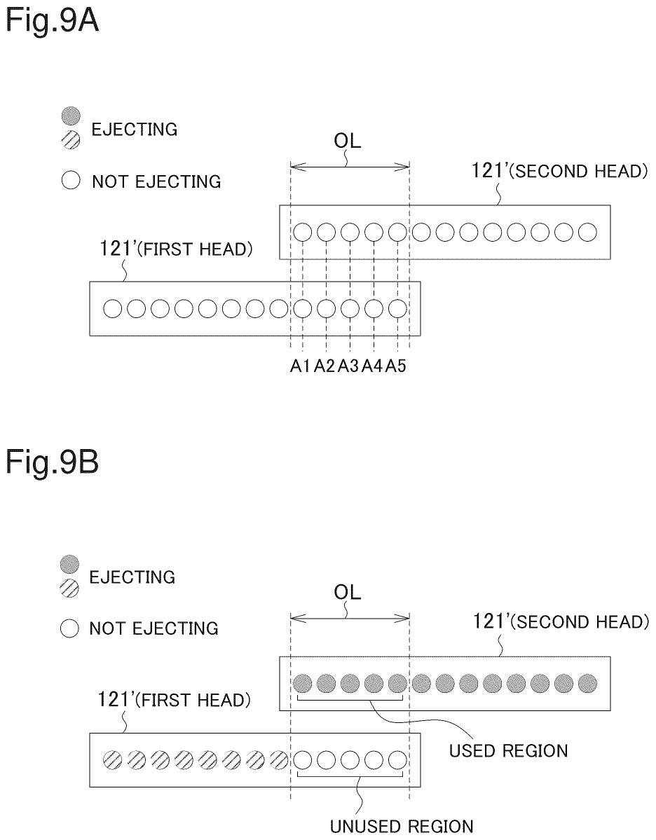

For the overlapping region, in general, the nozzles that eject the ink of the same color are provided in duplicate, along the recording sheet conveying direction. Although it is normal that only one of the nozzles provided in duplicate is used and the other is unused, continuously using only one of the nozzles may incur a defective printing result such as uneven density or appearance of streaks, owing to mounting error of the ink head, or ununiformity of the characteristics thereof. For example, when only the second head is used, without using the first head, for all the overlapping rows of the overlapping region, as shown in FIG. 9B, a defective printing result such as white streak or black streak may appear at the boundary, owing to minute shaking caused by the skew of the sheet.

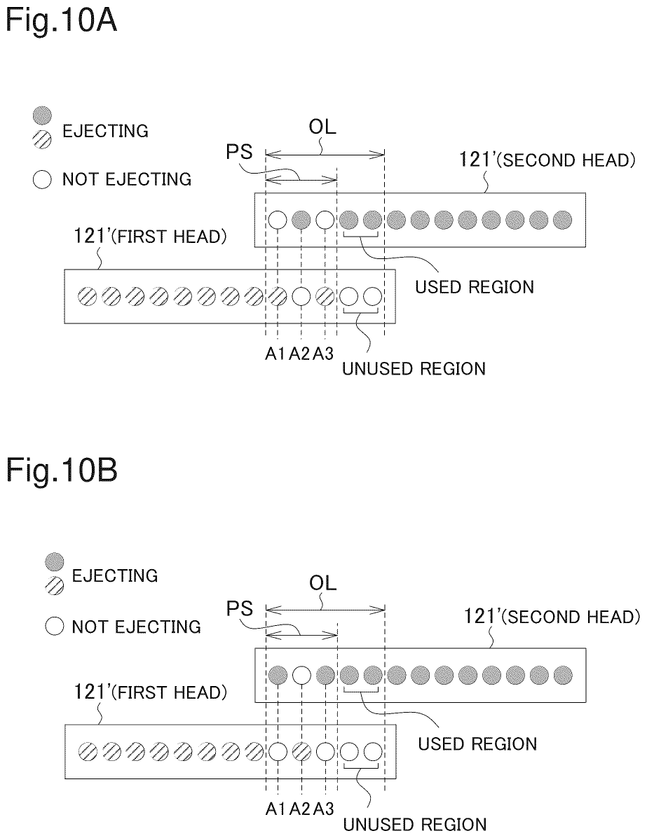

Accordingly, many of the existing inkjet printers are configured to execute the overlapping operation, including causing the ink head 121′ and the other ink head 121′ to eject the ink to the overlapping region OL, in the form of shared operation. As shown in FIG. 10A and FIG. 10B, for example, only the second head is used without using the first head for the overlapping rows A4 and A5 of the overlapping region OL, and the first head and the second head eject the ink to the overlapping rows A1 to A3 (overlapping operation region PS), in the form of shared operation. There are a plurality of patterns, in which the first head and the second head eject the ink to the overlapping rows A1 to A3 in the form of shared operation, as shown in FIG. 10A and FIG. 10B.

In the case of the line flushing also, the ink has to be ejected from the nozzle of both of the first head and the second head, overlapping in the overlapping region OL. However, in the case where the ink is ejected, when the opening of the revolving conveying belt has reached the ink ejection position from the nozzle along the conveying direction, from the corresponding nozzles of the first head and the second head, using the known flushing pattern as it is, the overlapping operation is not being performed, and the number of nozzles that eject the ink to the opening is fixed, according to the flushing pattern. Therefore, the ink ejection position toward the opening may be shifted in the width direction of the conveying belt, orthogonal to the conveying direction, and the ink may be ejected to a position on the conveying belt where the opening is not formed. As result, the line flushing may fail to be properly performed. Therefore, when performing the line flushing also, the overlapping operation for the line flushing pattern has to be performed.

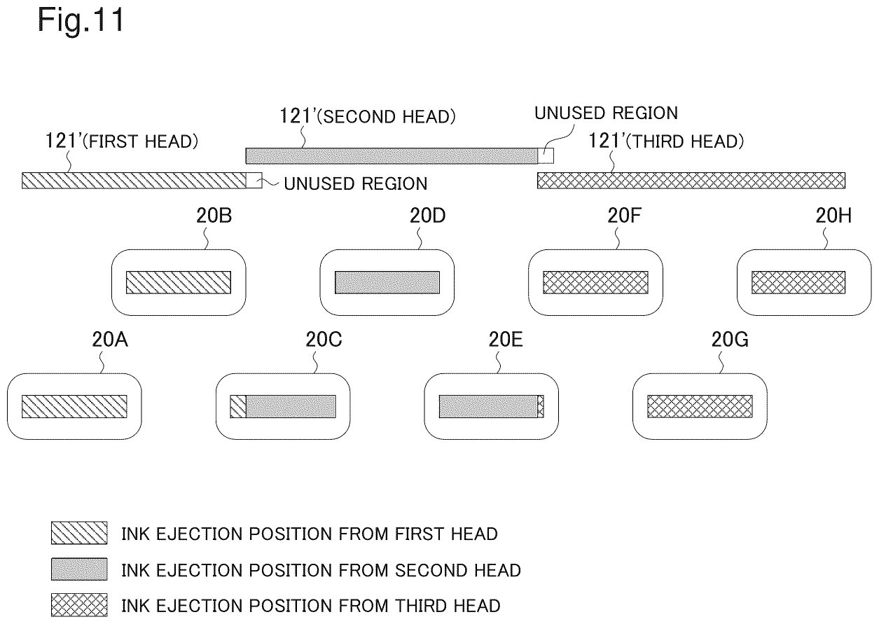

FIG. 11 and FIG. 12 are schematic drawings for explaining the positional relation between the ejection position of the ink ejected from the nozzles of the ink head 121, and the opening. The ink heads 121 (first head, second head, and third head) are arranged in the checkerboard pattern, along the width direction orthogonal to the conveying direction of the conveying belt. The openings 20A to 20H (hereinafter collectively “openings 20”, where appropriate) for the ink to pass therethrough, are formed in the conveying belt in the checkerboard pattern along the width direction.

FIG. 11 illustrates the line flushing, performed when the overlapping operation is not adopted in the image forming operation. FIG. 12 illustrates the line flushing, performed when the overlapping operation is adopted in the image forming operation.

By the line flushing performed when the overlapping operation is not adopted, the ink ejection positions from the nozzles are all located at the center of the opening 20, as shown in FIG. 11. However, by the line flushing performed when the overlapping operation is adopted, the ejection positions are shifted, and some of the ejection positions are deviated from the opening 20, as shown in FIG. 12.

For example, in the opening 20C shown in FIG. 12, the ink is ejected in duplicate from the two heads (first head and second head), so that the ink ejection positions overlap with each other. In the opening 20F, likewise, the ink is ejected in duplicate from the two heads (first head and second head), so that the ink ejection positions overlap with each other. In other words, the ink is ejected from the nozzles to be used for the overlapping operation, to the openings 20C and 20F.

Since the number of nozzles that eject the ink to the opening 20 (number of times of ink ejection) is fixed along the width direction, when the ink is ejected in duplicate at the position of the openings 20C and 20F, according to the flushing pattern, the ejection position from each nozzle is shifted in the width direction, by the amount corresponding to the number of nozzles that eject the ink in duplicate.

To enable the line flushing to be properly performed, while executing the overlapping operation, a flushing pattern has to be generated, by which the nozzles of the ink heads that eject the ink in accordance with the position of the opening are specified for the overlapping operation. However, a complicated process and large memory capacity are required, to generate such a flushing pattern.

With the arrangement according to the foregoing embodiment, in contrast, the line flushing, accompanied with the overlapping operation, can be accurately performed without a shift, with respect to the opening of the conveying belt, with a simple configuration and process.

Further, the configurations and processings described in the embodiments are merely exemplary, and in no way intended to limit the disclosure to those configurations and processings.

While the present disclosure has been described in detail with reference to the embodiments thereof, it would be apparent to those skilled in the art that various changes and modifications may be made therein within the scope defined by the appended claims.

What is claimed is;

1. An image forming apparatus comprising:
a conveying belt that includes a plurality of openings, and conveys a recording medium;
a plurality of ink heads that each include a plurality of nozzles aligned in a width direction, orthogonal to conveying direction of the conveying belt, and perform an image forming operation by ejecting ink from the plurality of the nozzles, onto the recording medium being conveyed by the conveying belt; and
a control device that includes a processor, and acts, when the processor executes a control program, as a controller that causes the ink heads to perform a flushing operation, including ejecting the ink from each of the nozzles toward one of the plurality of openings, at a different timing from a timing for executing the image forming operation, according to a flushing pattern, by which the nozzle of each ink head that ejects the ink to the opening, is designated with respect to each of the openings,
wherein the plurality of ink heads are arranged in a checkerboard pattern along the width direction, alternately shifted from each other in the conveying direction, so as to define an overlapping region, where a part of at least one ink head in the width direction overlaps with an adjacent ink head,
the flushing pattern is determined by increasing a number of nozzles of each of the ink heads, specified with respect to each of the openings, by a number of nozzles of each of the ink heads that are required to eject the ink in duplicate to the opening, to perform an overlapping operation, and
the controller executes, according to the flushing pattern, the overlapping operation including causing the nozzle of one of the ink heads overlapping with each other, and the nozzle of the other of the ink heads, to eject the ink to whole or part of the overlapping region, in a form of shared operation.

2. The image forming apparatus according to claim 1,
wherein the controller causes, instead of the shared operation, the nozzles of both of the ink heads overlapping with each other to eject the ink, to whole or part of the overlapping region, according to the flushing pattern.

3. The image forming apparatus according to claim 1,
wherein the controller changes the nozzle from which the ink is to be ejected, between the nozzle of one of the ink heads and the nozzle of the other of the ink heads, at a predetermined cycle during normal image forming operation, different from the flushing operation including ejecting the ink to whole or part of the overlapping region, according to the flushing pattern.

4. The image forming apparatus according to claim 1,
wherein the controller designates the nozzle that has ejected a smaller amount of ink, during a period from finish of an immediately preceding line flushing operation to a current line flushing operation, as the nozzle that ejects the ink to the overlapping region.
